(19) United States
(12) Patent Application Publication
(10) Pub. No.: US 2006/0166084 A1
(43) Pub. Date: Jul. 27, 2006

(54) Electrochemical generator with a liquid cathode

(75) Inventors: Philippe Chenebault, Poitiers (FR); BernardLe Simon, Le Taillan Medoc (FR)

Correspondence Address: SUGHRUE MION, PLLC, 2100 PENNSYLVANIA AVENUE, N.W., SUITE 800, WASHINGTON, DC, 20037, US

(73) Assignee: SAFT, Bagnolet (FR)

(21) Appl. No.: 11/303,997

(22) Filed: Dec. 19, 2005

(30) Foreign Application Priority Data
Dec. 28, 2004 (FR) 0413982

(51) Int. Cl. H01M 6/14; H01M 4/58

(52) U.S. Cl. 429/101; 429/231.95; 429/345

(57) ABSTRACT

The subject of the invention is an electrochemical generator with a liquid positive material comprising at least one metal anode and at least one cathode, characterized in that the cathode has a very low porosity, less than 0.1. A subject of the invention is also the use of a conductive element chosen from Mo, C, Ni, W and Ta for the production of a cathode with a porosity of less than 0.1.

### TECHNICAL FIELD

The subject of the invention is an electrochemical generator with a liquid cathode. Such a generator comprises an electrochemically active compound which is liquid.

### STATE OF THE ART

Primary electrochemical generators called electrochemical generators with a liquid cathode, of the lithium/thionyl chloride (Li/SOCl₂) type are known, and conventionally comprise a lithium anode and a carbon-based cathode. A standard carbon cathode comprises grains of carbon black which are compressed together, in the presence of a binder, conventionally PTFE.

Such a cathode generally has a very porous structure. The porosity value is defined in the following by the ratio of pore-volume to the geometric volume of the electrode. It can be associated with the concepts of true density dₜᵣᵤₑ, which is the theoretical density of the solid material, and of bulk density d_{bulk} of the material comprising the accessible or inaccessible pores. The relationship which links the true porosity with the true density and with the bulk density is the following:

$$Porosity = 1 - \frac{{d}_{bulk}}{{d}_{true}}$$

The porosity value of the cathode of a primary generator with a liquid cathode is generally 0.7 to 0.9. The cathode is impregnated with thionyl chloride, the liquid which constitutes the active cathode material. The thionyl chloride contains a dissolved salt which makes the ionic conductivity of the medium possible. During discharge of the generator, the thionyl chloride is reduced at the cathode. Insoluble sulphur and lithium chloride progressively precipitate in the porous cathode mass during discharge.

When the applications require large discharge pulses, the voltage of the generator falls as a result of polarizations. In order to maintain a high voltage at the terminals of the generator, the active surface area of the electrodes is increased in order to reduce the density of the current. When the active surface area of the electrodes is increased, the short circuit current is also increased in the case of short circuiting of the generator. In this case, the temperature of the generator can reach high temperatures. If the temperature reaches 180° C., the lithium melts and reacts very violently with the thionyl chloride.

In order to prevent thermal runaway phenomena, each generator is equipped with an external fuse in case of a short circuit. If this device is removed, the temperature of the generator becomes very high if there is a short circuit.

In the case of an internal short circuit, there is no system for limiting the current and the risk of thermal runaway remains. Under these conditions, the temperature which the cell reaches causes the safety vents to open.

Means are therefore sought to rapidly decrease the short circuit current of a primary generator (in particular of the Li/SOCl₂ type); whether it is in a situation where there is an internal short circuit or an external short circuit of the generator with failure of the external fuse.

### SUMMARY OF THE INVENTION

The aim of the invention is to reduce the risks of thermal runaway of a primary generator (in particular of the Li/SOCl₂ type) in the case of a short circuit. For this purpose the invention provides an electrochemical generator with liquid positive material comprising a metal anode and a cathode, characterized in that the cathode has a very low porosity, less than 0.1.

The use of a cathode with low porosity allows limitation of the duration of the short circuit current and therefore prevents the thermal runaway phenomena. The operating principle is based on the momentary blocking of the electrode by the insoluble reaction products, whereas in the case of a porous electrode it continues to operate because the discharge products can accumulate in the porosity.

Such an electrode with low porosity however allows a high pulsed discharge and discharge capacity to be obtained at a very low current.

### BRIEF DESCRIPTION OF THE FIGURES

Other characteristics of the invention will become apparent when reading the following description of the embodiment of the invention given by way of example and with reference to the figures.

FIG. 1 represents a schematic section view of a generator of the Li/SOCl₂ type according to the invention.

FIG. 2 represents the variation of the short circuit current as a function of time for:

(a) a generator according to the invention,

(b) a generator according to the state of the art,

during discharge through a resistance of 50 mΩ at a temperature of 20° C.

FIG. 3 represents the variation of the temperature as a function of time for:

(a) a generator according to the invention,

(b) a generator according to the state of the art,

during discharge through a resistance of 50 mΩ at a temperature of 20° C.

### DETAILED DESCRIPTION OF AN EMBODIMENT OF THE INVENTION

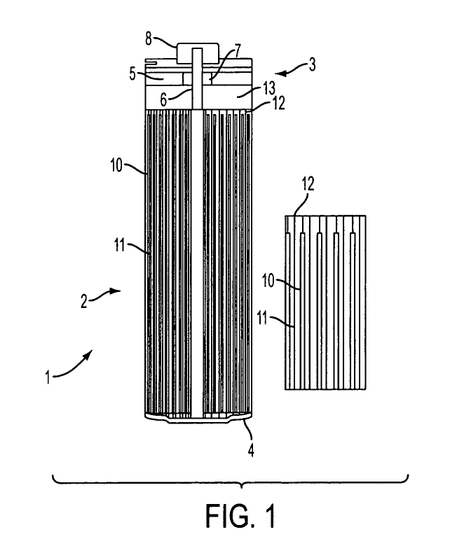

The Li/SOCl₂ type generator according to the invention can have a cylindrical, prism or button shape. In the example, it has a cylindrical shape. FIG. 1 represents a schematic section view of this generator.

The generator 1 comprises a container 2 having a cylindrical wall 3 closed by a base 4 at one end. The cylindrical wall 3 opens at the other end. A spiral winding with at least one negative electrode (anode) 10, at least one separator 11 and at least one positive electrode (cathode) 12 is introduced into the container 2.

The assembly can also be carried out with concentric cylindrical electrodes in which case the cathode is a tube opposite the lithium anode.

The container is filled with an electrolyte 13. A first cover 5 hermetically seals the open end. The tightness between the container 2 and this cover 5 is ensured by a weld. The central part 6 of this cover 5 is connected to the positive electrode. The central part 6 is electrically isolated from the cover 5, connected to the container, via a glass ring 7. A second cover 8 is welded on the central part 6 and serves as a positive terminal. The base 4 is connected to the negative electrode and serves as a negative terminal. A reverse arrangement of polarities is also possible.

The different components of the generator will now be described.

The metal of the anode is any suitable metal in the art for generators with a liquid cathode, and alkali and alkaline-earth metals and their alloys can be mentioned. Lithium will be preferred.

The material of the cathode 12 is the part which characterizes the generator according to the invention. This current-collecting material is constituted by an electron conducting material of low porosity. By material with low porosity is meant a material whose porosity is less than 0.1. Preferably, the porosity is less than 0.05. Still more preferably, the porosity is less than 0.02. Still more preferably the porosity is less than 0.01. The volume of the inaccessible closed pores can for example be determined by the helium pycnometry technique, which is a technique known to a person skilled in the art, and the total volume of the pores by the mercury pycnometry or mercury porosimetry method.

The weakly porous material can be, for example, chosen from the metal conductors which are stable in SOCl₂ and their mixtures such as molybdenum, carbon, nickel, tunsgsten and tantalum, certain steels, conductive metal oxides (TiO₂, SnO₂, etc.). Molybdenum will be preferred. The surface of the material can also be covered with one or more of these materials mentioned above.

The use of a weakly porous cathode allows direct use of metal foils as electrodes, which is considerably simpler than the standard method of producing porous carbon electrodes.

The porous carbon electrodes traditionally used in this type of generator with a liquid cathode incorporate a current collector of the extended or woven scrim type When they are cut out, burrs can be created which cause internal short circuits. The electrodes of the present invention avoid this type of drawback.

The separator is resistant to the electrolyte and can be made of glass fibres for example.

In a standard manner the electrolyte comprises a salt which can be chosen, for example, from (tetra)chloroaluminate, (tetra)fluoroborate, (tetra)bromochloroaluminate, (tetra)bromoborate, tetrachlorogallate, borohydrides, clovoborate and their mixtures. Tetrachloroaluminate and tetrachlorogallate salts will be preferred for the thionyl chloride. This salt is generally a metallic salt (generally that of the anode), but ammonium salts, in particular tetraalkylammonium salts can also be used. The preferred salt is a lithium salt. The salt concentration is comprised between 0.1 M and 2 M, preferably between 0.5 M and 1.5 M.

The solvent of the electrolyte is constituted by the liquid or gaseous oxidant, for example chosen from the group consisting of SOCl₂, SO₂, SO₂Cl₂, S₂Cl₂, SCl₂, POCl₃, PSCl₃. In the case of positive material in the form of gas, these materials are used conventionally dissolved in cosolvents, such as aromatic and aliphatic nitrites, DMSO, aliphatic amides, aliphatic or aromatic esters, cyclic or linear carbonates, butyrolactone, aliphatic or aromatic amines, these amines being primary or secondary or tertiary, and their mixtures. Aliphatic nitrites such as acetonitrile will be preferred. The concentration of dissolved positive material generally corresponds to the saturation, and is generally comprised between 60 and 90% by weight of electrolyte.

The preferred positive material is SOCl₂ or SO₂ or also SO₂Cl₂, the first two and in particular the very first one being particularly preferred.

The generator according to the invention has increased safety of use compared to standard Li/SOCl₂ generators.

The following example shows that such a generator is able to limit the duration of the discharge current, in the case of short circuiting of the generator.

### EXAMPLE

A traditional Li/SOCl₂ generator with a cylindrical AA shape known as “14500” (14 mm in diameter by 50 mm in height) and an Li/SOCl₂ generator with the same shape according to the invention were produced.

The positive electrode of the traditional generator is made of porous carbon. Its porosity is 0.7 to 0.9.

The positive electrode of the generator according to the invention is non-porous or slightly-porous (porosity less than 0.1). It is constituted by a sheet of molybdenum.

The negative electrodes of the two generators are made of metallic lithium.

The separator used for the two generators is made of glass fibre.

The two generators were filled with an electrolyte based on thionyl chloride (SOCl₂) containing 1.35 mol·L⁻¹ of LiAlCl₄.

Tests:

The electrical performance and the performance in terms of safety of use were compared.

The generators were short circuited through a low resistance of 50 mΩ. The temperature of the test is 20° C. The current discharged by the generators was measured as was their rise in temperature.

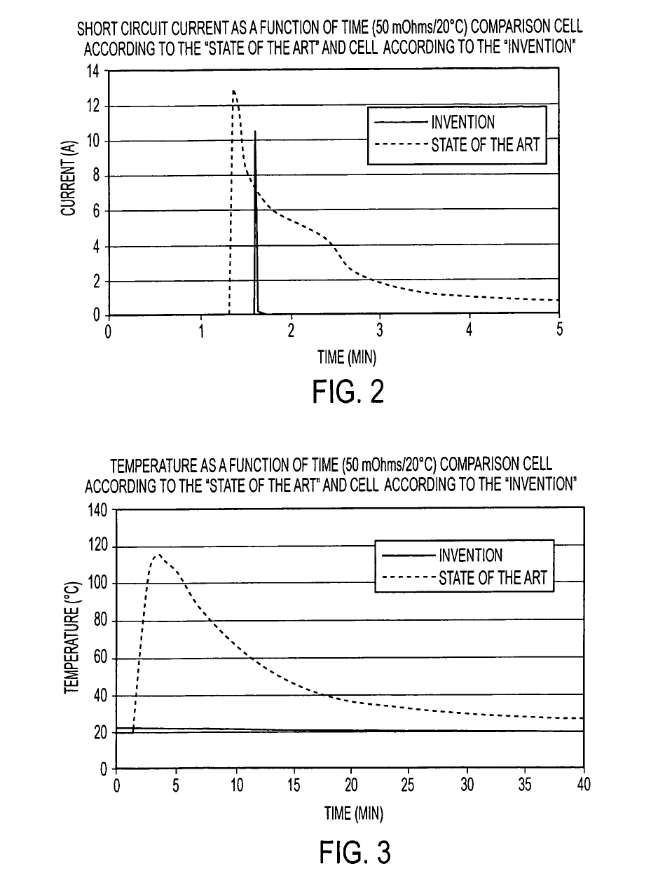

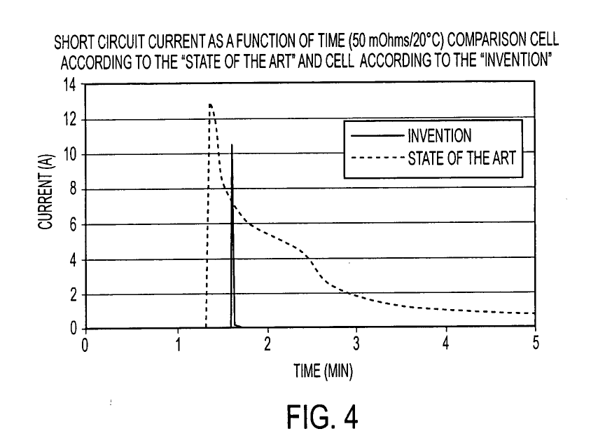

Table 1 and FIGS. 2 and 3 show the results of the tests.

TABLE 1
Results of the short circuit tests

| | Maximum current | Rise in temperature |
|---|---|---|
| | (A) | (° C.) |
| Traditional generator | 13 | +95 |
| Generator according to | 10.5 | 0 |
| the invention | | |

FIG. 2 shows that under short circuit conditions, the traditional generator discharges a current of 13 A, which does not immediately fall to zero. In fact, 3.5 minutes after the start of the short circuit, the current still has not reached zero.

By comparison, the generator according to the invention discharges a current peak of 10.5 A. Such a generator is able to make the short circuit current fall rapidly, in less than 5 seconds.

FIG. 3 shows that under short circuit conditions, the rise in temperature of the traditional generator reaches 95° C. By comparison, the temperature of the generator according to the invention does not increase.

1. Electrochemical generator (1) with liquid positive material comprising at least one metal anode (10) and at least one cathode (12), characterized in that said at least one cathode (12) has a porosity of less than 0.1.

2. Electrochemical generator according to claim 1, in which the porosity is less than 0.05.

3. Electrochemical generator according to claim 2, in which the porosity is less than 0.02, preferably less than 0.01.

4. Electrochemical generator according to claim 1, which is able to limit the duration of the discharge current in the case of short circuiting of the generator.

5. Generator according to claim 1, in which said at least one cathode (12) contains one or more conductive elements which are stable in thionyl chloride chosen from the group comprising metals, carbon, metal oxides.

6. Generator according to claim 5, in which said at least one conductive element is chosen from Mo, C, Ni, W and Ta.

7. Generator according to claim 6, in which said at least one conductive element is Mo.

8. Generator according to claim 5, in which said at least one conductive element is present at the surface of the cathode (12).

9. Generator according to claim 5, in which said at least one cathode (12) is constituted by one or more conductive elements.

10. Generator according to claim 1, in which said at least one cathode (12) is a metal foil.

11. Generator according to claim 1, in which said at least one anode (10) is made of lithium.

12. Generator according to claim 1, in which the liquid positive material is chosen from the group constituted by SOCl₂, SO₂ and SO₂Cl₂.

13. Generator according to claim 12, in which the liquid positive material is SOCl₂.

14. Generator according to claim 1, in which said at least one anode (10) and said at least one cathode (12) are arranged in a spiral assembly.

15. Use of a conductive element chosen from Mo, C, Ni, W and Ta for the production of a cathode with a porosity of less than 0.1.

16. Use of a conductive element according to claim 15, the conductive element being Mo.
